(19) United States
(12) Patent Application Publication
(10) Pub. No.: US 2026/0153381 A1
(43) Pub. Date: Jun. 4, 2026

(54) Metalenses for Use in Night-Vision Technology

(71) Applicant: Northeastern University, Boston, MA (US)

(72) Inventors: Ahmed BUSNAINA, Needham, MA (US); Anthony CHILDRESS, Jamaica Plain, MA (US)

(21) Appl. No.: 18/962,393

(22) Filed: Nov. 27, 2024

Related U.S. Application Data
(62) Division of application No. 17/581,186, filed on Jan. 21, 2022, now abandoned.
(60) Provisional application No. 63/140,191, filed on Jan. 21, 2021.

(51) Int. Cl. G01J 5/0806; G01J 5/08; G02B 1/00

(52) U.S. Cl. CPC G01J 5/0806; G01J 5/0853; G02B 1/007

(57) ABSTRACT

Thin film infrared (IR) imaging devices including a metalens layer configured to focus IR radiation onto a plasmonic absorber layer are provided for thin form factor and lightweight design of IR imaging devices. The devices can be produced using directed assembly methods and transfer printing of nanoelements. The fabrication methods are scalable and provide low cost means to produce the IR imaging devices.

### CROSS-REFERENCE TO RELATED APPLICATIONS

This is a divisional application of U.S. application Ser. No. 17/581,186, filed 21 Jan. 2022, and also claims priority to U.S. Provisional Application No. 63/140,191, filed 21 Jan. 2021. Each of the aforementioned applications is incorporated by reference herein in its entirety.

### BACKGROUND

Night-vision systems are employed by the military, law enforcement, game hunters, and in various sports. Current night-vision technologies rely on typical optical elements (glass lenses) and semiconductors for light manipulation and detection.

Typical night-vision devices rely on photomultipliers and phosphor screens, which make the devices large, heavy, and uncomfortable to wear when compared to typical eyewear. Another means of imaging is through thermal detection. This involves the detection of the infrared radiation that emanates from all objects. Since the range of emission wavelength spans several micrometers, the means of detection can require several different detectors and may require cooling for a useful signal. This also results in a large and heavy apparatus for detection. For both night-vision and thermal imaging, the form factor leaves much to be desired when the typical user is already carrying a large amount of gear in the field. Night-vision systems are an example of applications of infrared imaging devices, which are now utilized for vast technologies including archeological imaging, satellite imaging, spectroscopy, medical diagnosis, locating hidden/lost objects, undersea exploration, and deep field astronomy. As the applications have grown, there is a need to provide enhanced infrared detection with a form factor that approaches normal eyewear and with ease of manufacturing.

### SUMMARY

The present technology provides thin film-based infrared (IR) imaging devices that utilize nanoscale structures to form a metamaterial lens (metalens) combined with a plasmonic absorber to reduce the size and weight of the required hardware of night vision and related equipment. The metamaterial lens focuses incident IR and optionally visible electromagnetic radiation onto an adjacent plasmonic absorber used to detect the radiation and convert it into an electrical signal, which can be used to form an image. The use of metamaterials drastically reduces the size and weight (more than 100-fold) of night-vision systems and other imaging devices that utilize IR radiation. Nanoprinting methods can be used to fabricate both the metalens and the plasmonic absorber, as well as the underlying electronics, thus leading to a savings in cost of more than 10-fold.

The technology can be further summarized by the following list of features.

1. A thin film infrared (IR) imaging device comprising an array of pixels, each pixel comprising:
a metalens layer comprising a metalens substrate and a plurality of metalens nanostructures disposed on the metalens substrate, the plurality of metalens nanostructures configured to focus IR radiation in a near field beneath the metalens substrate;
a plasmonic absorber layer disposed beneath the metalens layer at a focal distance of the metalens layer, the plasmonic absorber comprising an absorber substrate and a plurality of absorber nanostructures disposed on the absorber substrate and configured to absorb and convert IR radiation transmitted by the metalens and incident on the absorber nanostructures to an electrical signal; and
an optional spacer layer disposed between the metalens layer and the plasmonic absorber layer.

2. The imaging device of feature 1, each pixel further comprising:
an circuit layer disposed beneath the plasmonic absorber layer, the circuit layer comprising an electronic circuit operative to receive the electrical signal produced by the plasmonic absorber layer, amplify the signal, and output the amplified signal as a measure of IR light incident on the pixel at the metalens layer.

3. The imaging device of feature 2, wherein the electronic circuit of the circuit layer comprises an analog to digital converter, and the output signal is a digital signal.

4. The imaging device of any of the preceding features, wherein the plasmonic absorber layer of each pixel comprises two or more different zones, each zone configured to absorb and convert IR radiation of a different wavelength range.

5. The imaging device of any of the preceding features, wherein the metalens layer further comprises a plurality of metalens nanostructures disposed on the metalens substrate and configured to focus incident visible light in a near field beneath the metalens substrate, and the plasmonic absorber layer further comprises a plurality of absorber nanostructures disposed on the absorber substrate and configured to absorb and convert visible light transmitted by the metalens and incident on the absorber nanostructures to an electrical signal.

6. The imaging device of any of features 1-5, wherein the metalens nanostructures are configured the same across all pixels.

7. The imaging device of any of features 1-5, wherein the metalens nanostructures are configured in pixels at a periphery of the metalens layer to capture and focus IR radiation of high incidence and in pixels at a center of the metalens layer to capture and focus light of low incidence.

8. The imaging device of feature 7, wherein the metalens nanostructures are configured to capture a gradient of high to low incidence IR radiation from the periphery to the center of the metalens layer.

9. The imaging device of any of the preceding features, wherein the device detects IR radiation over a wavelength range from about 600 nm to about 1 mm, or from about 780 nm to about 1 mm, or from about 780 nm to about 1.4 μm, or from about 1.4 μm to about 3.0 μm, or from about 3.0 μm to about 1 mm, or from about 2.5 μm to about 50 μm, or from about 50 μm to about 1 mm, or from about 0.6 μm to about 8 μm, or from about 0.6 μm to about 2.5 μm, or from about 8 μm to about 12 μm.

10. The device of any of features 2-9, wherein the electrical signal produced by the plasmonic absorber layer comprises a change in capacitance.

11. The device of any of the preceding features, wherein the metalens substrate comprises a material selected from the group consisting of organic polymers and resins, ZnSe, ZnS, silicon, and germanium.

12. The device of any of the preceding features, wherein the device comprises said spacer layer, and wherein the thickness of the spacer layer places the plasmonic absorber layer at a focal plane of the metalens layer.

13. The device of feature 12, wherein the spacer layer serves as the metalens substrate.

14. The device of any of the preceding features, wherein the metalens nanostructures comprise sintered nanoelements or solid material, and wherein the metalens nanostructures have dimensions from about 0.5 to about 2 μm arranged in an aperiodic array.

15. The device of any of the preceding features, wherein the absorber nanostructures comprise conducting or semi-conducting materials, or a combination thereof, and wherein the absorber nanostructures comprise a form selected from the group consisting of particles, rods, voids, pillars, or grids.

16. The device of any of the preceding features, wherein the pixels have a width or diameter in the range from about 10 μm to about 100 μm.

17. The device of any of features 2-16, further comprising a display whose input is connected to the output of the circuit layer, wherein the display is operative to provide a visible light image representing the IR radiation incident on the metalens layer.

18. The device of feature 17, wherein the display is configured as a screen, projection, or wearable optical device.

19. The device of any of the preceding features, wherein the device has dimensions less than about 20 cm and weight less than about 300 grams.

20. A method of making the thin film IR imaging device of any of the preceding features, the method comprising the steps of:
(a) providing a patterned metalens template, a metalens substrate material, a plurality of metalens nanomaterials, a patterned absorber template, an absorber substrate, a plurality of absorber nanomaterials;
(b) assembling, using a directed assembly method, the absorber nanomaterials on the absorber template according to the absorber template pattern to form a loaded absorber template;
(c) contacting the absorber substrate with the loaded absorber template, whereby absorber nanomaterials are transferred to the absorber substrate to form a plasmonic absorber layer;
(d) depositing the metalens substrate material onto the plasmonic absorber layer at the side containing the absorber nanomaterials to form a plasmonic absorber layer—metalens substrate composite;
(e) assembling, using a directed assembly method, the metalens nanomaterials on the metalens template according to the metalens template pattern to form a loaded metalens template; and
(f) contacting the plasmonic absorber layer—metalens substrate composite at the side opposite the absorber nanomaterials with the loaded metalens template, whereby metalens nanomaterials are transferred to the metalens substrate to form the device.

21. The method of feature 20, further comprising the step of:
(c1) depositing a spacer layer onto the plasmonic absorber layer—metalens substrate composite at the side containing the absorber nanostructures.

22. The method of feature 20 or 21, wherein the plasmonic absorber layer comprises an array of pixels.

23. The method of feature 22, wherein each pixel of the plasmonic absorber layer comprises two or more different zones, each zone configured to absorb and convert IR radiation of a different wavelength range, and wherein step (b) comprises assembling different nanostructures in each zone.

24. The method of any of features 20-22, wherein the directed assembly in step (b) and/or in step (e) comprises dip-coating the respective template in a liquid suspension of nanoelement and assembling nanoelements from the suspension on the template by a process comprising electrophoresis, dielectrophoresis, or fluidic assembly.

25. The method of feature 24, wherein the nanoelements are selected from the group consisting of metallic, semi-conducting, or insulating nanoparticles, nanorods, nanocrystals, quantum dots, and metallic or semiconducting nanotubes.

26. The method of feature 24 or 25, further comprising, after step (b) and/or (e):
fusing the assembled nanoelements.

27. The method of any of features 22-26, further comprising providing in step (a) a plurality of circuits corresponding to the pixel pattern of the plasmonic absorber layer, the circuits operative to receive electrical signals produced by the pixels of the plasmonic absorber layer, amplify the signals, and output the amplified signals and, after step (a), depositing the absorber substrate over the plurality of circuits.

28. The method of feature 27, further comprising assembling the plurality of circuits using a directed assembly method.

29. An IR imaging instrument comprising the device of feature 1, wherein the instrument is selected from the group consisting of a pair of night-vision glasses/goggles, a forward looking infrared (FLIR) camera, a redshifted telescope, a satellite imaging instrument, a pair of binoculars, a temperature sensor, a medical and/or industrial diagnostic instrument, a scope, tracking, and homing instrument.

As used herein, IR radiation, IR electromagnetic radiation, and IR light refers to electromagnetic radiation having wavelengths in the range from about 700 nm to about 1 mm. Visible electromagnetic radiation and optical electromagnetic radiation refer to electromagnetic radiation having wavelengths in the range from about 380 nm to about 700 nm. Near-IR refers electromagnetic radiation having wavelengths in the range from about 700 nm to about 1.3 μm. Mid-IR refers to electromagnetic radiation having wavelengths in the range from about 1.3 μm to about 3 μm. Thermal-IR refers to electromagnetic radiation having wavelengths in the range from about 3 μm to about 30 μm. Far-IR (FIR) refers to electromagnetic radiation having wavelengths in the range from about 15 μm to about 1 millimeter. As used herein, the term “field” can be used to describe a bandwidth of electromagnetic radiation or a wavelength range, for example, to describe near-IR as near field, to describe mid-IR as mid field, or to describe thermal-IR as thermal field, and the term “field” can be used to define a focal point of light, for example, as focusing in the near-field. As used herein, the term “electromagnetic radiation” can be used interchangeably with the term “light”. Light discussed herein can be unpolarized or polarized in a linear, circular, or elliptical polarization. Metalenses described herein optionally can provide polarization of light transiting through the metalens. Polarized light can be useful for spectroscopy and can be applied to research, for example, chemistry, materials science, physics, and astronomy. The present technology optionally can be applied for detection of filtered and polarized light. The technology can be utilized for IR imaging in series with linear polarizers or photoelastic modulators.

As used herein, an angle of incidence of incident light refers to the angle between a ray, representing the incident light, incident on a surface and a line perpendicular (normal) to the surface at the point of incidence. The angle of incidence may be referred to as an angle θ to the normal.

As used herein, the term “nanostructure” or “nanomaterial” refers to a structure having at least one dimension on the nanoscale, i.e., from about 1 nm to about 999 nm. Nanostructures can include, but are not limited to, nanosheets, nanotubes, nanoparticles, nanospheres, nanocylinders, nanowires, nanocubes, nanowalls, and combinations thereof.

As used herein, the term “microstructure” or “micromaterial” refers to a structure having at least one dimension on the microscale, that is, at least about 1 micrometer to about 999 micrometers.

As used herein, the term “about” refers to a range of within plus or minus 10%, 5%, 1%, or 0.5% of the stated value.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with the alternative expression “consisting of” or “consisting essentially of”.

### BRIEF DESCRIPTION OF THE DRAWINGS

FIG. 1A shows an example IR imaging device including a focusing metalens to focus incident light which is then absorbed at a preferred bandwidth by plasmonic arrays to yield an electrical signal. FIG. 1B shows an example IR imaging device including a metalens layer, a spacer layer, and an absorbing layer; the example pixels on the absorbing layer are shown with 4 types of absorbance arrays.

FIG. 2A shows an example of a metasurface used to manipulate incident light (Yu, et al., 2011). FIG. 2B shows an example of a metasurface used to manipulate incident light (Liu, et al., 2008). FIG. 2C (Prior Art) shows an example of a schematic for y-polarized excitation wherein the electric field is normal to the plane of incidence (Yu, et al., 2011). FIG. 2D shows a modeled plasmonic response of a nanopillar where the absorbance is calculated as a function of diameter, height, and spacing. FIG. 2E shows calculated absorbance spectra of the modeled nanopillar of FIG. 2D as a function of diameter, periodicity (p), and height (h), for a fixed diameter of 400 nm. FIG. 2F shows an example of plasmonic absorbance peaks resulting from a metallic grid (Sai, et al., 2003).

FIG. 3 shows a schematic illustration of a process for transfer printing of nanomaterials.

### DETAILED DESCRIPTION

Non-naturally occurring materials known as metamaterials include structures that can manipulate light in ways not found in naturally occurring materials. In an example, metamaterials can have a negative refractive index. Metamaterials and metasurfaces can be used to create flat or curved optics.

A metalens and a plasmonic absorber of the present technology, for example, applied to night vision devices, can be fabricated using the same methods. A method of fabrication can be top-down such as lithography and etching, or bottom-up, such as printing, plating, or assembly of nanoelements. The metalens can be designed such that it can focus light in the near-field, wherein the focal plane is very close to the metalens surface. In an example, a metalens produced by the present technology can also capture light received at a low angle of incidence and capture light received at a high angle of incidence, increasing the field of view compared to conventional optics, while maintaining a flat or a curved profile.

A plasmonic absorber or absorbing layer can include arrays of pillars or nanostructures, the size and spacing of which determine the absorbance characteristics of each array. A metalens can be positioned directly above the plasmonic absorber to focus light onto the absorbing array, which can absorb in the IR band of light. The absorbed light can then be transduced to an electrical signal by the field of the plasmonic absorbers, pixels on the absorbing layer, or arrays, allowing for an image to be displayed.

The present technology uses nanoscale structures such that light of an arbitrary wavelength can be absorbed efficiently and transduced into an electrical signal for imaging applications. Each pixel can include one or more layers. In an example, a pixel can include two layers, a top layer that serves as a guide to collimate incident light and can be constructed such that light is preferentially taken in from a certain angle of incidence, allowing for a wide field of view. Below this, a second layer serves to absorb light of the desired bandwidth allowing for electronic transduction. An absorption layer of each pixel can be designed with patterned areas of different scale, each of which absorbs at a different bandwidth. The absorption layer can be encapsulated within one or more organic or inorganic materials to provide structural integrity and to provide the proper spacing between absorber and metalens.

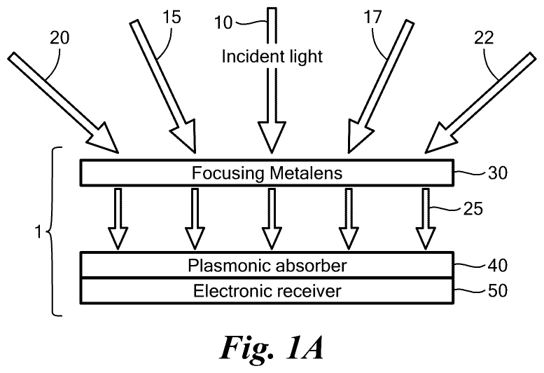

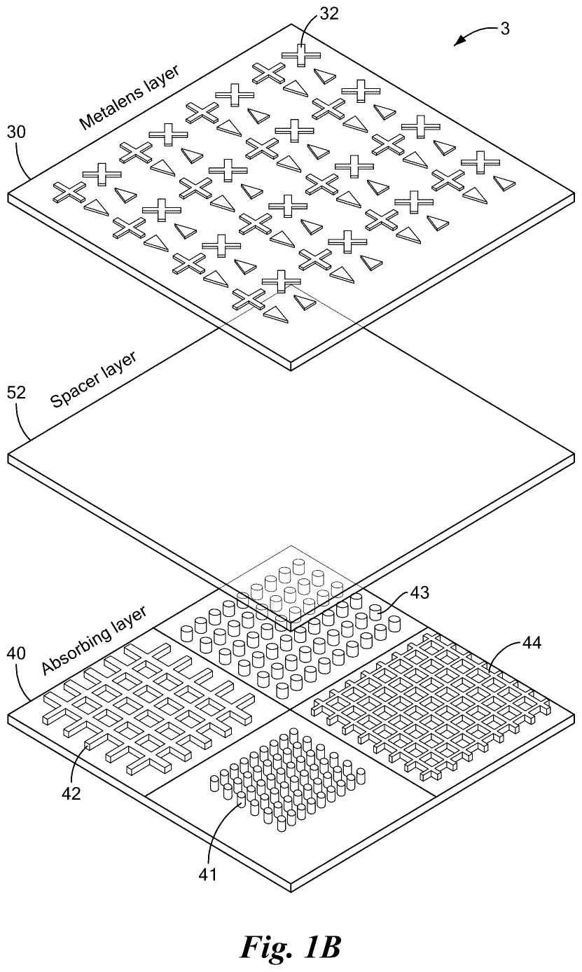

Below the absorbing layer, an amplifier circuit acts to magnify the change in electrical capacitance caused by the absorbance, thus yielding a signal that can be transformed into an image via a thin LED screen or a similar two-dimensional display. Diagrams of example layers and their functions are depicted in FIG. 1A and in FIG. 1B. The layers are thin and can also be flexible such that they can be applied to curved surfaces.

FIG. 1A depicts an example of a thin film IR imaging device 1 in side view. Incident light is focused via metalens 30 and absorbed at a preferred wavelength range by plasmonic absorber layer 40 to yield an electrical signal that is received by electronic receiver layer 50. A spacer layer (not shown) can be disposed between the focusing metalens 30 and the plasmonic absorber 40 so that the plasmonic absorber is positioned at the focal plane of the metalens. Electronic receiver layer 50 is disposed under the plasmonic absorbing layer and can receive an electrical signal produced by the plasmonic absorber layer, such as a change in capacitance of the absorber layer of a pixel, amplify the signal, and output the amplified signal as a measure of IR light incident on the pixel. The structures can be fabricated by the “bottom-up” directed assembly of nanomaterials, such as metallic and semiconducting nanoparticles, or can be fabricated by traditional “top-down” fabrication methods.

In FIG. 1B, an example of a thin film IR imaging device pixel 3 is depicted in a perspective view. The pixel 3 is shown with four types of absorbance arrays, each intended to absorb a different band of IR radiation. The focusing of IR radiation is achieved by the use of an exterior metalens layer 30, which includes an array of same or different nanostructures exemplified by structure 32. The plasmonic absorber layer 40 can include one or more types of nanostructures, exemplified by structures 41, 42, 43, and 44, disposed in one or more arrays. An optional spacer layer 52 is depicted between metalens layer 30 and absorbing layer 40.

The interaction of light with a material is governed by the material's electric permittivity (ε) and magnetic permeability (μ). Typical optical elements operate in the regime where both ε and μ are positive, and the material has a uniform dielectric function. For lensing, the thickness of the material is varied, resulting in a shift of the wavefront of the light once it exits the material. However, if an array of anisotropic light scatterers is made such that their characteristic length is less than the wavelength of the incident light, a phase gradient can be created at the incident surface, which causes a sudden shift in phase. These structures are known as metasurfaces and allow for the arbitrary shaping of wavefronts (Yu & Capasso, 2014; Aoni, et al., 2019). These metasurfaces are typically used to shift the direction and polarity of light.

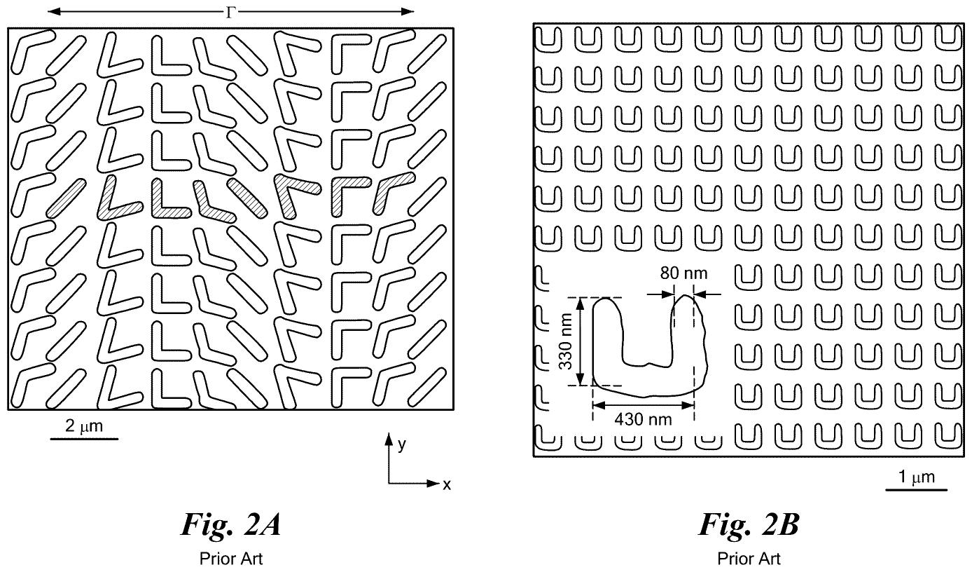

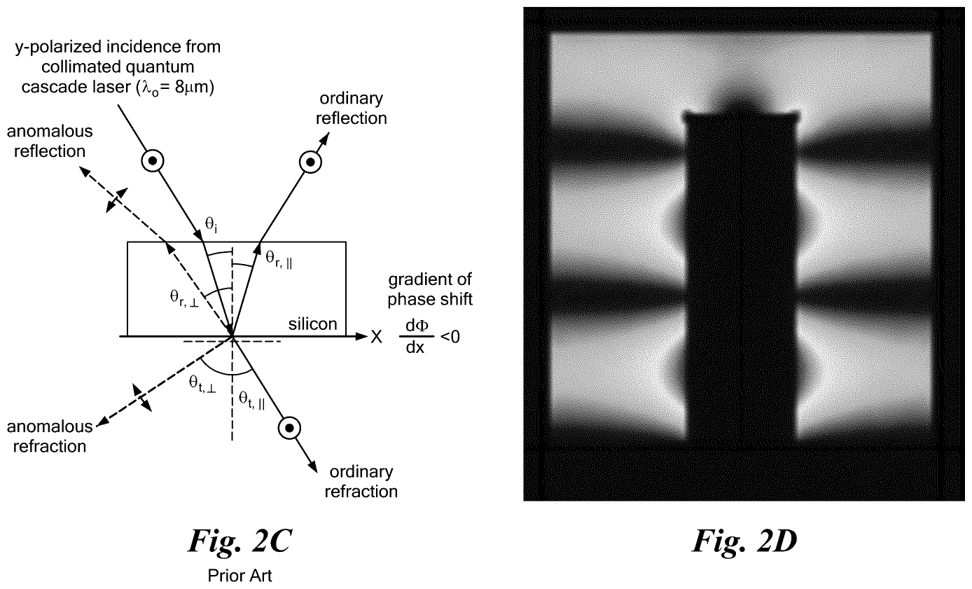

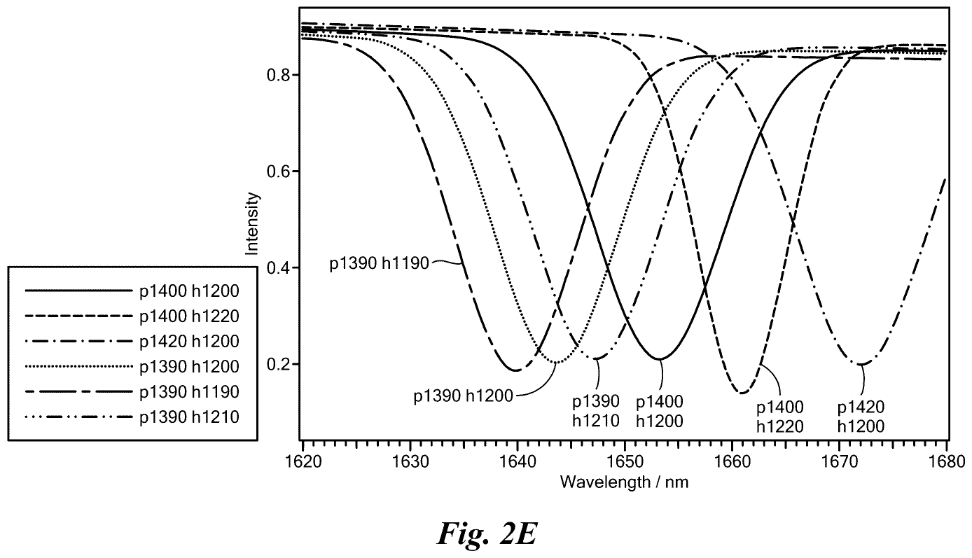

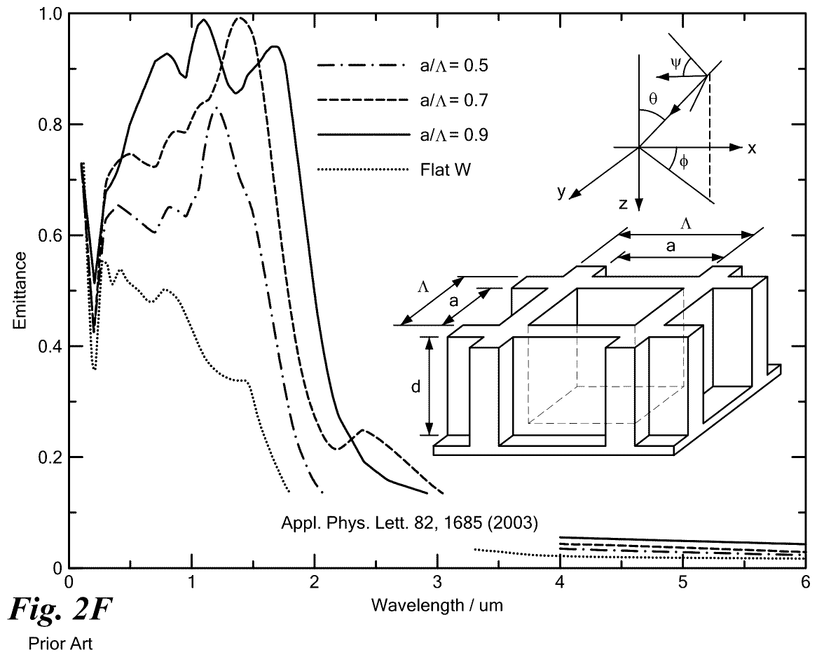

Over the past decade, metasurfaces have yielded various flat optical devices such as color holograms (Ni, et al., 2013; Jiang, et al., 2019) lasing cavities (Xu, et al., 2015), second harmonic generators (Marino, et al., 2019; Fedotova, et al., 2020; Chandrasekar, et al., 2015), and nanoscale spectrometers (Shaltout, et al., 2015). Much work has also been done on thin-film lenses known as metalenses (Wang, et al., 2017). The nanostructured arrangements on the surface can be in the form of cavities, nanoparticle clusters, or plasmonic antennas. The fabrication methods disclosed herein can be utilized for and are easily amenable to additive structures (plasmonic antennas), which are preferred. Examples of metamaterials are shown in FIGS. 2A-2F. FIGS. 2A-2C depict examples of metasurfaces used to manipulate incident light. FIG. 2D shows the modeled plasmonic response of a nanopillar where the absorbance is calculated as a function of diameter. FIG. 2E shows calculated absorbance spectra of the modeled nanopillar of FIG. 2D with a fixed diameter of 400 nm. FIG. 2F shows the plasmonic absorbance peaks of a metallic grid.

### Electrical Transduction of Optical Signals

Plasmonics refers to the confinement of electromagnetic energy at sub-wavelength scales through interactions between a conductive surface and incident light. Consider a metallic particle of a size less than or having a dimension less than the wavelength of the incident light. As used in this example, the term “particle” refers to a nanostructure. When the light is incident upon the particle, the oscillations of the electromagnetic field will cause oscillations of the free electrons of the particle. Because the particle size or a dimension is much less than the skin depth of bulk material, the polarization due to the incident field is not limited to the surface electrons but instead extends through the entire particle. This oscillation of electrons is called a surface plasmon (SP) and need not be limited to discreet particles. Any sub-wavelength conductive feature surrounded by a dielectric medium can give rise to SPs. Examples are pillars or grids. The grids may be particularly useful as they demonstrate a broad absorbance in the near and mid-infrared range (Yokoyama, et al., 2016; Maruyama, et al., 2001; Sai, et al., 2003). A SP can be characterized by a resonant frequency that depends on the feature's dimensions, dielectric function, and the dielectric function of the surrounding medium. If the resonant frequency of the feature matches that of the incident light, a large enhancement of the local field will occur. The field strength generated by the plasmonic response is proportional to the fluence of the incident light and can be measured as a change in capacitance in an underlying circuit used for signal amplification. Thus, the plasmonic response of the absorbers can be used for transduction into an electrical signal.

Prior to fabricating the nanostructures, they can first be modeled to confirm the shape and dimensions that give the proper electromagnetic response. For the case of periodic arrays such as those used for plasmonic absorbers, the modeling is not difficult. It involves solving the Maxwell equations with periodic boundaries and can be carried out with finite element software. Modeling for this this type for plasmonic arrays of nanopillars is done, as seen in FIG. 2D and in reference çetin, et al., 2011. Through modeling, the absorbance can be determined as a function of pillar height, diameter, and spacing. This can also be carried out for grids, as demonstrated in the literature. However, the modeling can be more complex for the metalens arrays, which often use aperiodic structures. For these structures, the finite difference time domain method (FDTD) is applied.

### Wide Field of View and Multiband Absorption

In order to have a wide field of view, the metalens can have a radially variable design such that light incident on the center will only be admitted if it is at a low angle of incidence while light at the edge will be at a high angle of incidence as depicted in FIG. 1A. In FIG. 1A, incident light is depicted at 10 having a low angle of incidence near a center of metalens 30 and having a high angle of incidence 20, 22 near an edge of the metalens. Incident light having intermediate angles of incidence, in the range between a low angle of incidence and a high angle of incidence, is depicted by 15 and 17. The incident light having different angles of incidence 10, 15, 17, 20, and 22 is collimated by the metalens into light 25 which is directed towards and focused at plasmonic absorbing layer 40. The metalens design can be varied as a gradient across its surface such that the edges are used to transmit light at a high angle of incidence while the center allows low angle of incidence. The metalens contains an aperiodic design of shapes, formed by metalens nanostructures disposed on the metalens substrate, to control the gradient of the phase of light passing through the nanostructures.

Several metalens designs are available to manipulate the direction of diffraction in this manner. For example, Aoni et al. rely on a semi-periodic array of discs with a gradient in diameter to achieve this effect (Aoni, et al., 2019). For a device of the present technology, a similar approach can be adopted to only accept light incident at certain angles. This light can then pass through a transparent spacer layer to the absorbing layer beneath.

A broad range of absorbance can be achieved by including several absorbing elements for each pixel, as shown in FIG. 1B. To cover the near and mid-infrared range, arrays of pillars and grids may be used. Previous work has characterized the absorbance characteristics of such structures (Sai, et al., 2003; çetin, et al., 2011; Yilmaz, et al., 2014; Chai, et al., 2020; Chai, et al., 2017; Cetin, et al., 2020).

Only light in the proper bandwidth would excite the plasmonic modes of these structures and cause a field enhancement that can be used as a signal. This allows for the detection and processing of multiple bandwidths of light. In an example, the dimension of each square pixel can be from about 10 μm to about 100 μm per side, which allows adequate room for the absorber elements. A pixel used in the technology can have a circular, elliptical, square, rectangular, triangular, or trapezoidal shape. The pixels have a width or diameter in the range from about 10 μm to about 100 μm. Below the absorber layer can be a circuit capable of transforming the change in field intensity for each subpixel to a useful signal. This requires a power source and amplifier circuit for detecting the change. The amplifier circuit can be implemented as an additional flat layer and does not significantly impact the form factor.

### Fabrication (Printing) of Metalenses and Absorbing Layers

To fabricate the structures, typical lithographic methods have been used in the past. However, these methods are very energy-intensive and are not amenable for applications on curved surfaces or for conformable substrates. Thus, it is preferred to fabricate the nanostructured arrays via the printing methods, such as those developed at the National Science Foundation (NSF) Center for High-Rate Nanomanufacturing of Northeastern University. Additive manufacturing methods can be used to fabricate the arrays. Additive printing methods are less wasteful than conventional fabrication and can also be accomplished with more compact and less expensive equipment. These features also make the additive printing methods attractive for trusted manufacturing since the equipment needed for production is affordable and can be used by smaller companies, government agencies, and labs instead of relying on a foundry for making the devices.

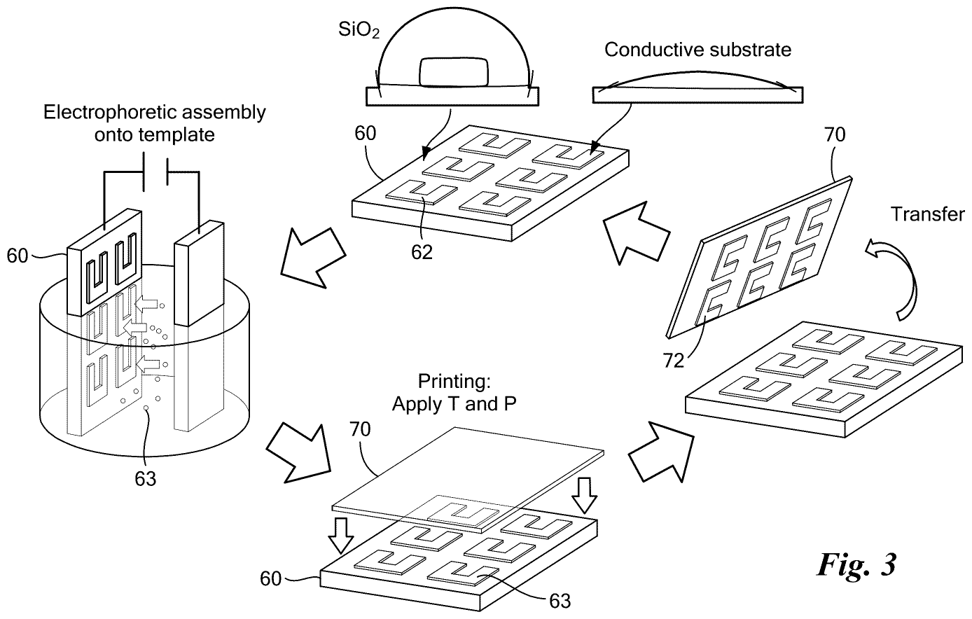

With these methods, the low-profile arrays can be printed using directed assembly of nanomaterials onto a template, then transferred to the desired substrate as depicted in FIG. 3. The nanomaterials can be assembled on the template using electrophoresis, dielectrophoresis, or fast fluidic assembly. In the process exemplified in FIG. 3, template 60 has been prepared using standard photolithography methods to deposit conductive elements 62 in the shapes of the desired nanostructures on a hydrophobic substrate (e.g., an amphiphile-coated SiO₂ substrate); the difference in contact angle between the hydrophobic substrate and hydrophilic conductive element is symbolized in the water droplets in the insets. As shown at the left side of FIG. 3, nanomaterials 63 suspended in a liquid (such as water or an aqueous solution) are deposited on conductive elements 62 via electrophoresis and/or dielectrophoresis (application of an electric potential between the conductive elements and a suspension electrode) or dip coating. At the bottom of FIG. 3, nanomaterials 63 previously deposited on the template are then transferred to substrate 70 by applying heat (T) and pressure (P). At the right side of FIG. 3, the substrate 70 carrying transferred nanomaterials formed into nanostructures 72 is removed from the template, yielding a completed device layer (e.g., metalens layer or plasmonic absorber layer). The template can then be cleaned and reused to form a number of further copies of the device layer. Any nanomaterial that can be suspended in an aqueous or other suitable liquid medium can be printed in this manner.

The template 60 is made using conventional fabrication and can be reused thousands of times, thus saving time and energy during fabrication. Templates can be used for printing on flexible substrates such as PET (polyethylene terephthalate), PETG (polyethylene terephthalate glycol-modified), PU (polyurethane), perylene, or another polymer. Polymer materials that absorb IR radiation can be used as substrates for the plasmonic absorber layer or for an electrical circuit layer; however, IR transparent materials must be used for the substrate of the metalens layer, at least for the wavelength band detected by the device. The plasmonic absorber substrate does not necessarily need to absorb strongly in the IR, as long as the light can reach the plasmonic absorber. IR transparent materials include silicon, germanium, zinc selenide, zinc sulfide, and halide salts of alkali metals and alkaline earth metals, as well as metal oxides.

The nanostructures also can be printed directly on the substrate surface without the need for transfer printing using directed assembly approaches. The fabrication can be simplified if the light to be absorbed is in the infrared range of the spectrum. The proper function of the metalens and absorption layer requires the feature size of the nanoarrays to be less than the wavelength of the incident light. For optical (visible) frequencies, the features must be less than 400 nm in size, which necessitates the use of e-beam, DUV, immersion, or EUV lithography to pattern the substrate. This process is either very time consuming or very expensive. However, for larger feature sizes suitable for absorbing IR light, the features can be patterned using typical optical lithography, which is much easier to accomplish in terms of time and effort. For an example IR imaging application where features less than 600 nm in size will be unnecessary, a laser writing system will be suitable for relatively fast wafer-scale patterning of the template or substrate without the need for a mask. A Heidelberg laser write system can be used for this purpose.

A spacer layer, metalens layer, or a plasmonic absorber layer can include a coating, for example, for insulation, modification of refractive index, collimation, focusing, filtering of unwanted bandwidths, prevention of water/moisture exposure, prevention of reflection, or thermal insulation.

Transparent materials for a spacer layer, coating, or for a metalens substrate can include or consist of, for example, with transparency ranges, poly(methyl methacrylate) up to 2.8 μm, Ge₃₃As₁₂ Se₅₅ glass (0.8-13 μm), barium fluoride (0.15-12.5 μm), potassium bromide (0.21-28 μm), cesium iodide (0.25-55 μm), potassium chloride (0.21-21 μm), cadmium telluride (2-25 μm), sapphire (0.17-5.0 μm), silicon (1.2-10, 50-100 μm), high resistivity silicon (1.2-10, 50-100 μm), calcium fluoride (0.15-9.0 μm), gallium arsenide (1-15 μm), sodium chloride (0.2-20 μm), germanium (2-17 μm), BK7 Schott Glass (0.35-2.0 μm), fused silica UV grade (0.18-3.5 μm) or fused silica IR grade (0.18-3.5 μm), lithium fluoride vacuum UV grade (0.12-6.5 μm), magnesium fluoride (0.13-7.0 μm), quartz (0.15-3.3 μm), thallium bromoiodide KRS-5 (0.6-40 μm), zinc selenide or zinc selenide laser grade (0.55-20 μm), zinc sulfide cleartran (0.37-14 μm), IR plastic (8-12 and 15-40 μm), copper aluminum oxide (CuAlxOy) in a delafossite, amorphous, combination, or other crystal form (0.7 μm to about 30 μm), silver bromide, silver chloride, or a combination thereof. Any of the above listed materials can be in amorphous, crystalline, glass, or a combination form (infraredtraininginstitute.com). Optically clear polymers or resins having low absorbance in the wavelength range of interest (IR and/or visible) also can be used as material for the metalens substrate and/or the spacer layer.

Materials for making nanostructures for the metalens or plasmonic absorber can include titanium dioxide, metals, titanium, gold, silver, silicon, silicon nitride, graphene, copper, bismuth, palladium, platinum, aluminum, carbon, titanium nitride, glass, plastics and other polymers (e.g., PMMA, PDMS), aluminum scandium nitride, semiconductors/semiconductor layers, or a combination thereof. The form of the materials of nanostructures can be amorphous, crystalline, monocrystalline, polycrystalline, glass, or a combination thereof. Nanostructures of a metalens can possess dimensions in the range from about 500 nm to about 2 μm, with larger dimensions, for example, if a nanowall structure is formed with a longer length and a nanodimensional width. Nanostructures on a plasmonic absorber layer can include nanodimensions of less than about 1 μm, with larger dimensions, for example, if a nanogrid is formed including longer wall lengths.

The plasmonic absorber substrate can be any material that can support the device and amplifier circuit such that it is mechanically stable, and which is compatible with fabrication methods. An example is a pre-shaped piece of flexible plastic that has the circuit already in place or a solid semiconductor depending on how the circuit and absorber and metalens are integrated. Thickness can be comparable to a working electronics chip on silicon, in the range from about 100 μm to about 300 μm. A plasmonic absorber layer can include thermal insulation. For example, an insulating coating can be applied. The absorber layer can be encapsulated, for example, in a resin or from an inorganic material that can be applied using chemical vapor deposition or a spin on dielectric, as long as it is transparent in the range of interest.

The thickness of the metalens substrate can be in the range from about 10 μm to about 50 μm, for example.

The following patents describe methods that can be used for fabrication of the metalens and plasmonic absorber, and are hereby incorporated by reference: Nanoscale interconnects fabricated by electrical field directed assembly of nanoelements, Busnaina A, Yilmaz C, Kim T, Somu S (2015) U.S. Pat. No. 8,937,293B2 High rate electric field driven nanoelement assembly on an insulated surface, Sirman A, Busnaina A, Yilmaz C, Huang J, Somu S (2015) U.S. Pat. No. 9,145,618B2; Damascene template for directed assembly and transfer of nanoelements, Busnaina, A., Cho, H., Somu, S., Huang, J (2016) U.S. Pat. No. 9,365,946B2.

The present technology provides many advantages over previous technologies. For example, the devices incorporate nanomaterials, use metalenses and plasmonic absorbers, and are relatively thin compared to traditional optics. In another example, the devices provide night vision capability with an Improved form factor and lighter weight compared to conventional technology, making them more comfortable to wear.

The devices can be produced by scalable methods, allowing for relatively low cost devices. The devices can be produced by providing a patterned metalens template, a metalens substrate material, a plurality of metalens nanomaterials, a patterned absorber template, an absorber substrate, and a plurality of absorber nanomaterials. The absorber nanomaterials can be assembled, using a directed assembly method, on the absorber template according to the absorber template pattern to form a loaded absorber template. The absorber substrate can then be contacted with the loaded absorber template, whereby absorber nanomaterials are transferred to the absorber substrate to form a plasmonic absorber layer. The metalens substrate material can then be deposited onto the plasmonic absorber layer at the side containing the absorber nanomaterials to form a plasmonic absorber layer - metalens substrate composite. Optionally, a spacer or separator layer can be positioned onto the plasmonic absorber layer at the side containing the absorber nanomaterials. The separator layer between the metalens and plasmonic absorber can be used for proper spacing and it can serve to encapsulate the plasmonic absorber. The metalens substrate material can then be deposited onto the spacer layer at the side opposite the side of the spacer layer in contact with the absorber nanomaterials to form a plasmonic absorber layer - spacer layer metalens - substrate composite. A separator layer that overlays or encapsulates the plasmonic absorber can be made from a resin or from an inorganic material that could be applied using chemical vapor deposition or a spin on dielectric, as long as it is transparent in the range of interest. This can be a metal oxide as discussed above. On top of a hardened separator layer, the metalens layer can be applied, and nanoimprint lithography can be used on the metalens given that the underlying layers have been encapsulated. Using a directed assembly method, assembling the metalens nanomaterials on the metalens template according to the metalens template pattern to form a loaded metalens template; and contacting the plasmonic absorber layer - metalens substrate composite (or optionally the plasmonic absorber layer - spacer layer metalens - substrate composite) at the side opposite the absorber nanomaterials with the loaded metalens template, whereby metalens nanomaterials are transferred to the metalens substrate to form the device.

An amplifier circuit layer can be fabricated first and then coated with a resist or substrate required for making the plasmonic absorber layer. This way the absorber will be in direct contact with the amplifier circuit layer. The plasmonic absorber layer and metalens layer can then be fabricated sequentially on top of the circuit layer.

In another example, the amplifier circuitry is not fabricated together with the fabrication of the plasmonic absorber layer. The amplifier circuitry can be external to the plasmonic substrate or chip that serves as the platform for the absorber and metalens. The amplifier circuit can interface with the plasmonic absorber layer at each pixel.

In another example, the metalens can be produced separately, the plasmonic absorber produced separately, and then the metalens and plasmonic absorber are pressed together either with or without a spacer between them. The plasmonic absorber layer can be produced with pixels and electrical contacts beneath the pixels that align with electrical contacts on a commercially available amplification chip.

### Example 1. Fabrication of an IR Imaging Device

A damascene template with a poly-methyl-methacrylate (PMMA) positive resist layer over a conductive layer is patterned into a circuit design including nanoscale features using electron-beam lithography. For electrophoretic assembly, the patterned damascene template and a bare gold chip are placed, separated, into an aqueous suspension of gold nanoparticles, and a voltage is applied to the suspension. Nanoparticles are transported and assembled into the circuit design of the damascene template. A circuit substrate of thin, flexible polymer film is contacted with the damascene template, and temperature and pressure are applied to transfer the nanoparticles from the damascene template to the substrate. The template is removed from the substrate, yielding the circuit layer.

A plasmonic absorber layer is fabricated on top of the circuit layer. A PMMA resist layer is spin coated over the circuit layer and serves as the substrate of the absorber layer as well as serving to seal and protect the circuit layer. A damascene template with a PMMA layer over a conductive layer is patterned into the plasmonic absorber design including nanoscale features using electron-beam lithography. The patterned absorber template and a bare gold chip are placed into an aqueous suspension of gold nanoparticles, and a voltage is applied to the suspension. Nanoparticles are transported and assembled into the absorber design of the damascene template. The nanoparticle-loaded template is contacted with the absorber substrate, and temperature and pressure are applied to transfer the nanoparticles from the absorber template to the absorber substrate. The template is removed from the substrate, the device containing the circuit layer covered by the plasmonic absorber layer. The absorber can also be assembled directly on top of the circuit layer by coating the circuit layer with PMMA and writing the pattern in the PMMA. After development, the particles that compose the nanostructured absorber can be assembled using electrophoresis as mentioned previously.

A spacing layer is formed over the plasmonic absorber layer by sputtering a layer of copper aluminum oxide over the nanostructures of the plasmonic absorber layer. The thickness of the spacing layer allows the absorber structures to lie at the focal plane of the to be fabricated metalens.

A layer of titanium dioxide is added by sputtering onto the top of the spacing layer and serves as the metalens substrate. A metalens template of PMMA over a conductive layer is patterned using electron-beam lithography. The patterned metalens template and a bare gold chip are placed, separated, in an aqueous suspension of titanium dioxide nanoparticles, and a voltage is applied to the suspension. Nanoparticles are transported and assembled onto the nanoscale features of the metalens template. The metalens substrate is contacted with the template, and temperature and pressure are applied to transfer the nanoparticles to the metalens substrate. The template is removed from the substrate, yielding the metalens layer and the completed imaging device.

### REFERENCES

1. Yu N, Capasso F, Flat optics with designer metasurfaces. Nature Materials 13 (2) (2014) 139-150. doi.org/10.1038/nmat3839

2. Aoni R A, Rahmani M, Xu L, Zangeneh Kamali K, Komar A, Yan J, Neshev D, Miroshnichenko A E, High-Efficiency Visible Light Manipulation Using Dielectric Metasurfaces. Scientific Reports 9 (1) (2019) 1-9. doi.org/10.1038/s41598-019-42444-y

3. Ni X, Kildishev A V., Shalaev V M, Metasurface holograms for visible light. Nature Communications 4 (1) (2013) 1-6. doi.org/10.1038/ncomms3807

4. Jiang Q, Jin G, Cao L, When metasurface meets hologram: principle and advances. Advances in Optics and Photonics 11 (3) (2019) 518. doi.org/10.1364/aop.11.000518

5. Xu L, Curwen C A, Hon P W C, Chen Q S, Itoh T, Williams B S, Metasurface external cavity laser. Applied Physics Letters 107 (22) (2015) 221105. doi.org/10.1063/1.4936887

6. Marino G, Gigli C, Rocco D, Lemaître A, Favero I, Angelis C De, Leo G, Zero-Order Second Harmonic Generation from AlGaAs-on-Insulator Metasurfaces. ACS Photonics 6 (5) (2019) 1226-1231. doi.org/10.1021/acsphotonics.9b00110

7. Fedotova A, Younesi M, Sautter J, Vaskin A, Löchner F J F, Steinert M, Geiss R, Pertsch T, Staude I, Setzpfandt F, Second-Harmonic Generation in Resonant Nonlinear Metasurfaces Based on Lithium Niobate. Nano Letters (2020) acs.nanolett.0c03290. doi.org/10.1021/acs.nanolett.0c03290

8. Chandrasekar R, Emani N K, Lagutchev A, Shalaev V M, Cirací C, Smith D R, Kildishev A V., Second harmonic generation with plasmonic metasurfaces: direct comparison of electric and magnetic resonances. Optical Materials Express 5 (11) (2015) 2682. doi.org/10.1364/ome.5.002682

9. Shaltout A, Liu J, Kildishev A, Shalaev V, Photonic spin Hall effect in gap-plasmon metasurfaces for on-chip chiroptical spectroscopy. Optica 2 (10) (2015) 860. doi.org/10.1364/optica.2.000860

10. Wang W, Guo Z, Zhou K, Ran L, Sun Y, Shen F, Fan G, Li Y, Qu S, Liu S, Metalens Focusing the Co-/cross-polarized Lights in Longitudinal Direction. Plasmonics 12 (1) (2017) 69-75. doi.org/10.1007/s11468-016-0230-5

11. Yokoyama T, Dao T D, Chen K, Ishii S, Sugavaneshwar R P, Kitajima M, Nagao T, Spectrally Selective Mid-Infrared Thermal Emission from Molybdenum Plasmonic Metamaterial Operated up to 1000° C. Advanced Optical Materials 4 (12) (2016) 1987-1992. doi.org/10.1002/adom.201600455

12. Maruyama S, Kashiwa T, Yugami H, Esashi M, Thermal radiation from two-dimensionally confined modes in microcavities. Applied Physics Letters 79 (9) (2001) 1393-1395. doi.org/10.1063/1.1397759

13. Sai H, Kanamori Y, Yugami H, High-temperature resistive surface grating for spectral control of thermal radiation. Applied Physics Letters 82 (11) (2003) 1685-1687. doi.org/10.1063/1.1560867

14. çetin A E, Yanik A A, Yilmaz C, Somu S, Busnaina A, Altug H, Monopole antenna arrays for optical trapping, spectroscopy, and sensing. Applied Physics Letters 98 (11) (2011) 111110. doi.org/10.1063/1.3559620

15. Yilmaz C, Cetin A E, Goutzamanidis G, Huang J, Somu S, Altug H, Wei D, Busnaina A, Three-Dimensional Crystalline and Homogeneous Metallic Nanostructures Using Directed Assembly of Nanoparticles. ACS Nano 8 (5) (2014) 4547-4558. doi.org/10.1021/nn500084g

16. Chai Z, Korkmaz A, Yilmaz C, Busnaina A A, High-Rate Printing of Micro/Nanoscale Patterns Using Interfacial Convective Assembly. Advanced Materials 32 (22) (2020) 2000747. doi.org/10.1002/adma.202000747

17. Chai Z, Yilmaz C, Busnaina A A, Lissandrello C A, Carter D J D, Directed assembly-based printing of homogeneous and hybrid nanorods using dielectrophoresis. Nanotechnology 28 (47) (2017) 475303.

18. Cetin A E, Yilmaz C, Galarreta B C, Yilmaz G, Altug H, Busnaina A, Fabrication of Sub- 10-nm Plasmonic Gaps for Ultra-Sensitive Raman Spectroscopy. Plasmonics 15 (4) (2020) 1165-1171. doi.org/10.1007/s11468-020-01137-3.

19.(infraredtraininginstitute.com/thermograpahy-information/infrared-transparent-materials/).

1. A method of making a thin film IR imaging device, the method comprising the steps of:
(a) providing a patterned metalens template, a metalens substrate material, a plurality of metalens nanomaterials, a patterned absorber template, an absorber substrate, and a plurality of absorber nanomaterials;
(b) assembling, using a directed assembly method, the absorber nanomaterials on the absorber template according to the absorber template pattern to form a loaded absorber template;
(c) contacting the absorber substrate with the loaded absorber template, whereby absorber nanomaterials are transferred to the absorber substrate to form a plasmonic absorber layer;
(d) depositing the metalens substrate material onto the plasmonic absorber layer at the side containing the absorber nanomaterials to form a plasmonic absorber layer - metalens substrate composite;
(e) assembling, using a directed assembly method, the metalens nanomaterials on the metalens template according to the metalens template pattern to form a loaded metalens template; and
(f) contacting the plasmonic absorber layer—metalens substrate composite at the side opposite the absorber nanomaterials with the loaded metalens template, whereby metalens nanomaterials are transferred to the metalens substrate to form the device.

2. The method of claim 1, further comprising the step of:
(c1) depositing a spacer layer onto the plasmonic absorber layer—metalens substrate composite at the side containing the absorber nanostructures.

3. The method of claim 2, wherein the thickness of the spacer layer places the plasmonic absorber layer at a focal plane of the metalens substrate.

4. The method of claim 1, wherein the plasmonic absorber layer comprises an array of pixels.

5. The method of claim 4, wherein each pixel of the plasmonic absorber layer comprises two or more different zones, each zone configured to absorb and convert IR radiation of a different wavelength range, and wherein step (b) comprises assembling different nanostructures in each zone.

6. The method of claim 1, wherein the directed assembly in step (b) and/or in step (e) comprises dip-coating the respective template in a liquid suspension of nanoelements and assembling nanoelements from the suspension on the template by a process comprising electrophoresis, dielectrophoresis, or fluidic assembly.

7. The method of claim 6, wherein the nanoelements are selected from the group consisting of metallic, semi-conducting, or insulating nanoparticles, nanorods, nanocrystals, quantum dots, and metallic or semiconducting nanotubes.

8. The method of claim 6, further comprising, after step (b) and/or (e):
fusing the assembled nanoelements.

9. The method of claim 4, further comprising providing in step (a) a plurality of circuits corresponding to the pixel pattern of the plasmonic absorber layer, the circuits operative to receive electrical signals produced by the pixels of the plasmonic absorber layer, amplify the signals, and output the amplified signals and, after step (a), depositing the absorber substrate over the plurality of circuits.

10. The method of claim 9, further comprising assembling the plurality of circuits using a directed assembly method.

11. The method of claim 1, wherein the transfer of absorber nanomaterials of step (c) and/or the transfer of metalens nanomaterials of step (f) comprises application of heat and/or pressure.

12. The method of claim 1, wherein the thin film IR imaging device is configured for use in an IR imaging instrument selected from the group consisting of a pair of night-vision glasses/goggles, a forward looking infrared (FLIR) camera, a redshifted telescope, a satellite imaging instrument, a pair of binoculars, a temperature sensor, a medical and/or industrial diagnostic instrument, a scope, tracking, and homing instrument.

13. The method of claim 1, wherein the metalens nanomaterials form metalens nanostructures configured to capture a gradient of high to low incidence IR radiation from the periphery to the center of the metalens layer.

14. The method of claim 1, further comprising integrating the thin film IR imaging device into a device comprising a display configured as a screen, projector, or wearable optical device.
